(19) United States
(12) Patent Application Publication
(10) Pub. No.: US 2021/0119859 A1
(43) Pub. Date: Apr. 22, 2021

(54) Topology Agnostic Security Services

(71) Applicant: Cisco Technology, Inc., San Jose, CA (US)

(72) Inventors: Saravanan Radhakrishnan, Bangalore (IN); Anand Oswal, Pleasanton, CA (US); Paul Wayne Bigbee, Palo Alto, CA (US); Darrin Joseph Miller, Marysville, OH (US); Thomas Leslie Peter Wood, Colts Neck, NJ (US)

(21) Appl. No.: 16/991,556

(22) Filed: Aug. 12, 2020

Related U.S. Application Data
(60) Provisional application No. 62/923,930, filed on Oct. 21, 2019.

(51) Int. Cl. H04L 12/24; H04L 29/06

(52) U.S. Cl. CPC H04L 41/0803; H04L 63/02

(57) ABSTRACT

Systems and methods are provided for receiving service instructions from a client regarding a network function at a network element, the service instructions including a table of network policies and rules, receiving data from a first edge node of a network fabric, processing the data received from the first edge node according to the service instructions regarding the network function, and providing the processed data to a second edge node of the network fabric based on the service instructions.

### CROSS-REFERENCE TO RELATED APPLICATIONS

This application claims priority to U.S. Provisional Application No. 62/923,930, filed on Oct. 21, 2019, the content of which is incorporated herein by reference in its entirety.

### TECHNICAL FIELD

The subject matter of this disclosure relates in general to the field of computer networking, and more particularly, to systems and methods for delivering security in a topology agnostic manner.

### BACKGROUND

The enterprise network landscape is continuously evolving. There is a greater demand for mobile and Internet of Things (IoT) device traffic, Software as a Service (SaaS) applications, and cloud adoption. In addition, security needs are increasing and certain applications can require prioritization and optimization for proper operation. As this complexity grows, there is a push to reduce costs and operating expenses while providing for high availability and scale.

In conventional enterprise deployments, introduction of security is tied to a network topology. However, such a topology includes several disadvantages. In some deployments, customers may require a firewall to be inserted in the network to monitor the east-west traffic for compliance requirements. However, the volume of east-west traffic is minimal, which results in lightly-loaded firewalls. In other deployments, firewalls are positioned at a particular point in the network that creates a network traffic bottleneck because of the volume of traffic that needs to be processed at the particular point in the network. Furthermore, installing multiple firewalls incurs significant operational and capital expenditure.

Not only are firewalls utilized to increase security, but encryption is also a factor when considering security functions in the enterprise. With an increase in the volume of encrypted traffic, the capacity of the firewall will be pressured by the need to successfully compute intensive decryption of the encrypted data.

The current approach for including security services is completely dependent on the topology. Some vendors host security in a cloud. However, this approach includes challenges including the inability to pass the required context to the cloud. Also, this approach consumes expensive WAN bandwidth to get all of the network traffic to the cloud. Furthermore, it is very challenging to get the enterprise local traffic to the cloud. Another approach includes the introduction of a physical firewall, but this includes similar challenges as described above.

### BRIEF DESCRIPTION OF THE FIGURES

To provide a more complete understanding of the present disclosure and features and advantages thereof, reference is made to the following description, taken in conjunction with the accompanying drawings, in which:

FIG. 1A illustrates an example of a physical topology for an enterprise network in accordance with an embodiment of the present disclosure;

FIG. 1B illustrates an example of a logical architecture for an enterprise network, such as the enterprise network of FIG. 1A, in accordance with an embodiment of the present disclosure;

FIG. 2 illustrates an example of a heterogeneous wireless network in accordance with an embodiment of the present disclosure;

FIG. 3 illustrates an example of a topology for an enterprise network including policy enablement, in accordance with some embodiments;

FIG. 4 illustrates an example of a topology for an enterprise network where firewalls may not be a part of the fabric, in accordance with some embodiments;

FIG. 5 illustrates a table in accordance with the embodiment of FIG. 4;

FIG. 6 illustrates an example of a topology for an enterprise network where firewalls may be a part of the fabric, in accordance with some embodiments;

FIG. 7 illustrates an example table in accordance with the embodiment of FIG. 6;

FIG. 8 illustrates an example process for delivering security in a topology agnostic manner, in accordance with some embodiments;

FIG. 9 illustrates an example of a network device, in accordance with some embodiments; and

FIGS. 10A and 10B illustrate examples of systems, in accordance with some embodiments.

### DESCRIPTION OF EXAMPLE EMBODIMENTS

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

Systems and methods provide for delivering security in a topology agnostic manner. For example, systems and methods are provided for receiving service instructions from a client regarding a network function at a network element, receiving data from a first edge node of a network fabric, processing the data received from the first edge node according to the service instructions regarding the network function, and providing the processed data to a second edge node of the network fabric based on the service instructions.

### Example Embodiments

An example of a network architecture for implementing aspects of the present technology is described below. However, one of ordinary skill in the art will understand that, for the network architecture and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

Enterprise networks can be designed and deployed to provide wireless network access for general-purpose computing devices (e.g., servers, workstations, desktop computers, laptop computers, tablets, mobile phones, etc.) and things (e.g., desk phones, security cameras, lighting, HVAC, windows, doors, locks, medical devices, industrial and manufacturing equipment, and other IoT devices) (sometimes also referred to as clients, servers, hosts, computing systems, endpoints, electronic devices, user devices, User Equipment (UE) devices, etc.) within environments such as offices, hospitals, colleges and universities, oil and gas facilities, factories, and similar locations. With wireless network access, these devices can connect to private networks (e.g., campus or access networks, data centers, branch networks, etc.) and public networks (e.g., the Internet, Infrastructure as a Service (IaaS) networks, Platform as a Service (PaaS) networks, Software as a Service (SaaS) networks, other Cloud Service Provider (CSP) networks, etc.) without being tethered to a specific location. The wireless network access technologies can include Wireless Personal Area Networks (WPANs) (e.g., BLUETOOTH, ZIGBEE, Z-WAVE, etc.), WI-FI (e.g., Institute of Electrical Electronic Engineers (IEEE) 802.11x, such as 802.11a, 802.11h, 802.11g, 802.11n, 802.11ac, 802.11ax, etc.) or Wireless Local Area Networks (WLANs), and Wireless Wide Area Networks (WWANs) or cellular networks (e.g., 4G/LTE, 5G, etc.).

Another wireless network access technology that can be integrated by enterprise networks is Citizens Broadband Radio Service (CBRS) (sometimes also referred to as private LTE, private 5G, OnGo, etc.). CBRS operates in a 150 MHz wide spectrum of the 3.5 GHz band (e.g., 3550-3700 MHz frequency range in the United States), and thus CBRS is unlikely to interfere or be interfered with by WI-FI and cellular devices. For some devices, like life-sustaining medical equipment that need guaranteed, always-on connectivity or industrial IoT devices or other robots that have specific mobility requirements, CBRS can complement WI-FI, cellular, and other wireless networks.

WI-FI, cellular, and CBRS networks have different advantages and drawbacks relative to one another. Building a cellular network to provide ubiquitous, robust connectivity (e.g., backhaul links cannot be cut, cellular network infrastructure is often restored first after a disaster, etc.) to devices operating across vast distances can be a costly endeavor that relies on monthly and metered subscriptions to cover expenses. WI-FI network equipment can connect devices within the same general physical location, such as a home or a building, and is relatively inexpensive in comparison. In addition, WI-FI operates in unlicensed frequencies that do not require bidding for rights to use them. Mobile and cellular standards are also different from WI-FI in that a cellular device can require a significantly higher license cost for the technology itself. For example, WI-FI devices, which are based on IEEE standards, can have a per-device cost for associated licenses that is dramatically lower than for LTE/4G or 5G devices.

Cellular networks may be suitable for mobile usage in cases in which it can be critical for a user to have a consistent, persistent connection. For example, a mobile user may walk from place to place while making a phone call, answer email from a bus, or stream a podcast while driving, and so on. These may be situations in which the user may be intolerant of gaps in network coverage. The mobile user is also unlikely to consume a lot of data under these circumstances. WI-FI and CBRS networks, on the other hand, may be particularly suitable for nomadic usage where it can be more important to have a stable connection (e.g., relatively more tolerant of coverage gaps) and to be able to consume large amounts of data at little to no cost. For example, a nomadic user can decamp from place to place but may sit down for extended periods of time to do data-intensive work, such as receiving large files, editing them, and sending them back online. The same users, on the same devices, can be mobile users or nomadic users at different periods of times, and network operators are beginning to incorporate WI-FI, cellular, and CBRS network infrastructure into their own networks for increased flexibility, availability, and capacity, among other benefits. However, it can be challenging to manage these separate access technologies as integrated systems with unified policy, security, and analytics in view of the differences among them in terms of cost, infrastructure layout, the level of administrative control they can provide, and the like. Users and devices need to move between these different wireless systems, and network operators want the experience to be seamless and easy to manage at scale.

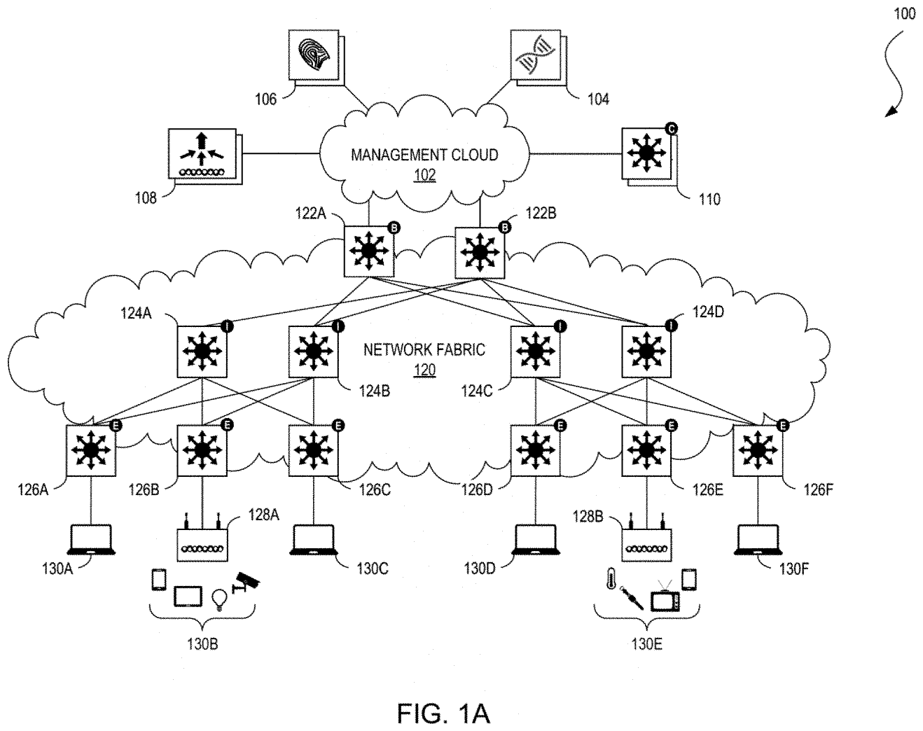

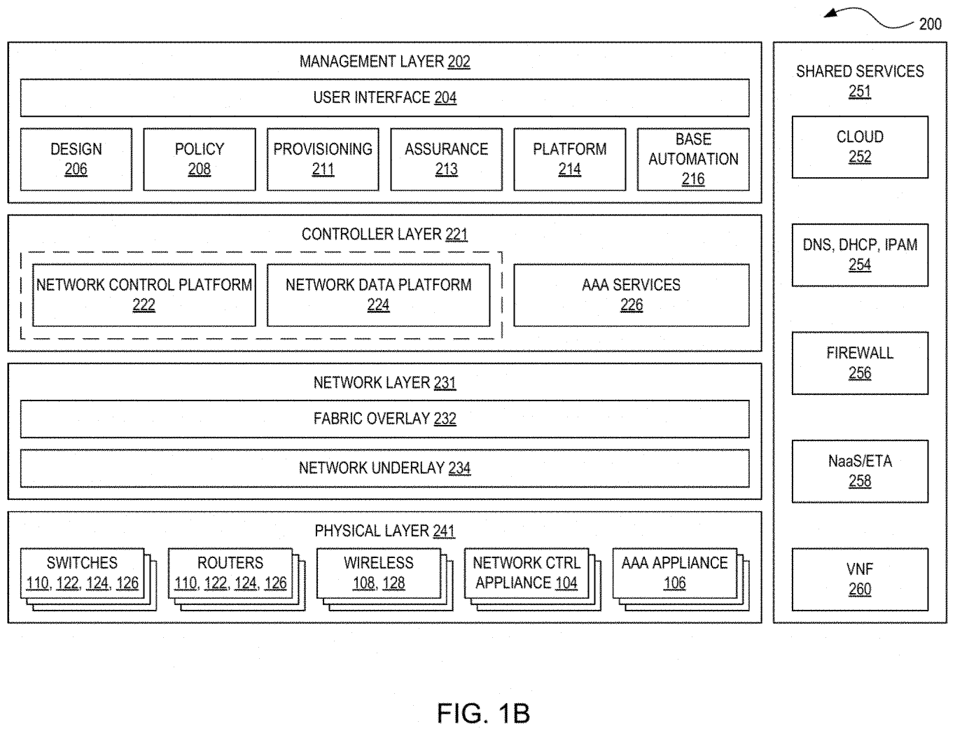

Turning now to the drawings, FIG. 1A illustrates an example of an enterprise network 100. It should be understood that, for the enterprise network 100 and any network discussed herein, there can be additional or fewer nodes, devices, links, networks, or components in similar or alternative configurations. Example embodiments with different numbers and/or types of endpoints, nodes, cloud components, servers, software components, devices, virtual or physical resources, configurations, topologies, services, appliances, or deployments are also contemplated herein. Further, the enterprise network 100 can include any number or type of resources, which can be accessed and utilized by endpoints or network devices. The illustrations and examples provided herein are for clarity and simplicity.

In this example, the enterprise network 100 includes a management cloud 102 and a network fabric 120. Although shown as an external network or cloud to the network fabric 120 in this example, the management cloud 102 may alternatively or additionally reside on the premises of an organization or in a colocation center (in addition to being hosted by a cloud provider or similar environment). The management cloud 102 can provide a central management plane for building and operating the network fabric 120. The management cloud 102 can be responsible for forwarding configuration and policy distribution, as well as device management and analytics. The management cloud 102 can comprise one or more network controller appliances 104, one or more AAA appliances 106, wireless network infrastructure equipment 108 (e.g., WLCs, EPC equipment, 4G/LTE or 5G Core network equipment, etc.), and one or more fabric control plane nodes 110. In other embodiments, one or more elements of the management cloud 102 may be co-located with the network fabric 120.

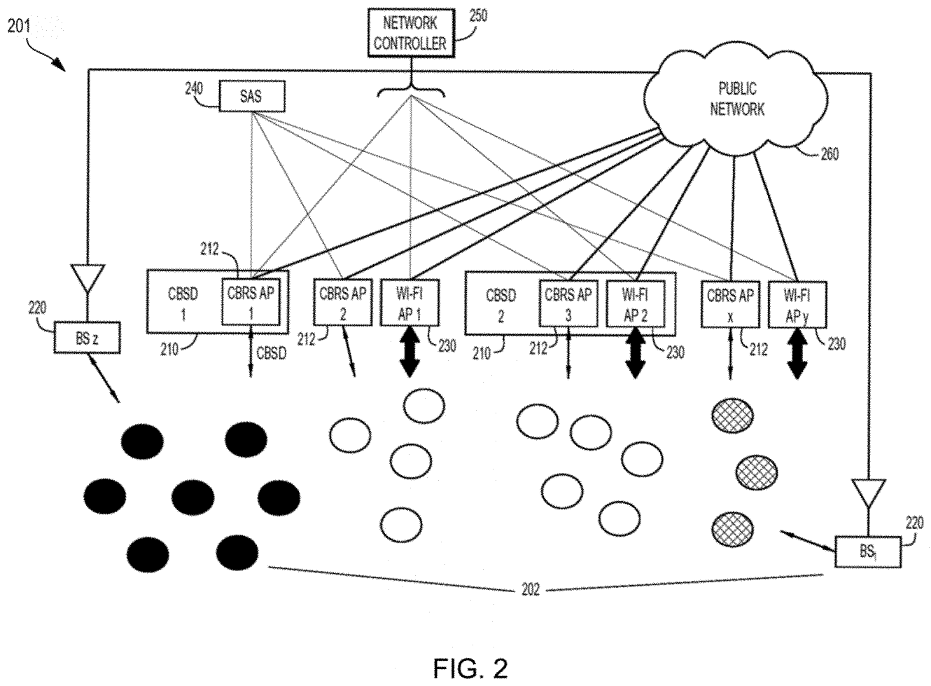

The network controller appliances 104 can function as the command and control system for one or more network fabrics, and can house automated workflows for deploying and managing the network fabrics. The network controller appliances 104 can include automation, design, policy, provisioning, and assurance capabilities, among others, as discussed further below with respect to FIG. 2. In some embodiments, one or more Cisco Digital Network Architecture (Cisco DNA™) appliances can operate as the network controller appliances 104.

The AAA appliances 106 can control access to computing resources, facilitate enforcement of network policies, audit usage, and provide information necessary to bill for services. The AAA appliance can interact with the network controller appliances 104 and with databases and directories containing information for users, devices, things, policies, billing, and similar information to provide authentication, authorization, and accounting services. In some embodiments, the AAA appliances 106 can utilize Remote Authentication Dial-In User Service (RADIUS) or Diameter to communicate with devices and applications. In some embodiments, one or more Cisco® Identity Services Engine (ISE) appliances can operate as the AAA appliances 106.

The wireless network infrastructure equipment 108 can support fabric-enabled base stations and access points attached to the network fabric 120, handling traditional tasks associated with a WLC or 4G/LTE or 5G Core network equipment as well as interactions with the fabric control plane for wireless endpoint registration and roaming. In some embodiments, the network fabric 120 can implement a wireless deployment that moves data-plane termination (e.g., Virtual Extensible Local Area Network (VXLAN)) from a centralized location (e.g., with previous overlay Control and Provisioning of Wireless Access Points (CAPWAP) deployments) to a wireless base station or access point/fabric edge node. This can enable distributed forwarding and distributed policy application for wireless traffic while retaining the benefits of centralized provisioning and administration. In some embodiments, one or more Cisco® Catalyst® controllers, Cisco® Wireless Controllers, Cisco® Wireless Local Area Network (LAN), and/or other Cisco DNA™-ready wireless controllers can operate as the wireless network infrastructure equipment 108.

The network fabric 120 can comprise fabric border nodes 122A and 122B (collectively, 122), fabric intermediate nodes 124A-D (collectively, 124), and fabric edge nodes 126A-F (collectively, 126). Although the fabric control plane nodes 110 are shown to be external to the network fabric 120 in this example, in other embodiments, the fabric control plane nodes 110 may be co-located with the network fabric 120. In embodiments where the fabric control plane nodes 110 are co-located with the network fabric 120, the fabric control plane nodes 110 may comprise a dedicated node or set of nodes or the functionality of the fabric control nodes 110 may be implemented by the fabric border nodes 122.

The fabric control plane nodes 110 can serve as a central database for tracking all users, devices, and things as they attach to the network fabric 120, and as they roam around. The fabric control plane nodes 110 can allow network infrastructure (e.g., switches, routers, WLCs, etc.) to query the database to determine the locations of users, devices, and things attached to the fabric instead of using a flood and learn mechanism. In this manner, the fabric control plane nodes 110 can operate as a single source of truth about where every endpoint attached to the network fabric 120 is located at any point in time. In addition to tracking specific endpoints (e.g., /32 address for IPv4, /128 address for IPv6, etc.), the fabric control plane nodes 110 can also track larger summarized routers (e.g., IP/mask). This flexibility can help in summarization across fabric sites and improve overall scalability.

The fabric border nodes 122 can connect the network fabric 120 to traditional Layer 3 networks (e.g., non-fabric networks) or to different fabric sites. The fabric border nodes 122 can also translate context (e.g., user, device, or thing mapping and identity) from one fabric site to another fabric site or to a traditional network. When the encapsulation is the same across different fabric sites, the translation of fabric context is generally mapped 1:1. The fabric border nodes 122 can also exchange reachability and policy information with fabric control plane nodes of different fabric sites. The fabric border nodes 122 also provide border functions for internal networks and external networks. Internal borders can advertise a defined set of known subnets, such as those leading to a group of branch sites or to a data center. External borders, on the other hand, can advertise unknown destinations (e.g., to the Internet similar in operation to the function of a default route).

The fabric intermediate nodes 124 can operate as pure Layer 3 forwarders that connect the fabric border nodes 122 to the fabric edge nodes 126 and provide the Layer 3 underlay for fabric overlay traffic.

The fabric edge nodes 126 can connect endpoints to the network fabric 120 and can encapsulate/decapsulate and forward traffic from these endpoints to and from the network fabric. The fabric edge nodes 126 may operate at the perimeter of the network fabric 120 and can be the first points for attachment of users, devices, and things and the implementation of policy. In some embodiments, the network fabric 120 can also include fabric extended nodes (not shown) for attaching downstream non-fabric Layer 2 network devices to the network fabric 120 and thereby extend the network fabric. For example, extended nodes can be small switches (e.g., compact switch, industrial Ethernet switch, building automation switch, etc.) which connect to the fabric edge nodes via Layer 2. Devices or things connected to the fabric extended nodes can use the fabric edge nodes 126 for communication to outside subnets.

In some embodiments, all subnets hosted in a fabric site can be provisioned across every fabric edge node 126 in that fabric site. For example, if the subnet 10.10.10.0/24 is provisioned in a given fabric site, this subnet may be defined across all of the fabric edge nodes 126 in that fabric site, and endpoints located in that subnet can be placed on any fabric edge node 126 in that fabric. This can simplify IP address management and allow deployment of fewer but larger subnets. In some embodiments, one or more Cisco® Catalyst switches, Cisco Nexus® switches, Cisco Meraki® MS switches, Cisco® Integrated Services Routers (ISRs), Cisco® Aggregation Services Routers (ASRs), Cisco® Enterprise Network Compute Systems (ENCS), Cisco® Cloud Service Virtual Routers (CSRvs), Cisco Integrated Services Virtual Routers (ISRvs), Cisco Meraki® MX appliances, and/or other Cisco DNA-ready™ devices can operate as the fabric nodes 122, 124, and 126.

The enterprise network 100 can also include wired endpoints 130A, 130C, 130D, and 130F and wireless endpoints 130B and 130E (collectively, 130). The wired endpoints 130A, 130C, 130D, and 130F can connect by wire to fabric edge nodes 126A, 126C, 126D, and 126F, respectively, and the wireless endpoints 130B and 130E can connect wirelessly to wireless base stations and access points 128B and 128E (collectively, 128), respectively, which in turn can connect by wire to fabric edge nodes 126B and 126E, respectively. In some embodiments, Cisco® Catalyst® access points, Cisco Aironet® access points, Cisco Meraki® MR access points, and/or other Cisco DNA™-ready access points can operate as the wireless base stations and access points 128.

The endpoints 130 can include general purpose computing devices (e.g., servers, workstations, desktop computers, etc.), mobile computing devices (e.g., laptops, tablets, mobile phones, etc.), wearable devices (e.g., watches, glasses or other head-mounted displays (HMDs), ear devices, etc.), and so forth. The endpoints 130 can also include Internet of Things (IoT) devices or equipment, such as agricultural equipment (e.g., livestock tracking and management systems, watering devices, unmanned aerial vehicles (UAVs), etc.); connected cars and other vehicles; smart home sensors and devices (e.g., alarm systems, security cameras, lighting, appliances, media players, HVAC equipment, utility meters, windows, automatic doors, door bells, locks, etc.); office equipment (e.g., desktop phones, copiers, fax machines, etc.); healthcare devices (e.g., pacemakers, biometric sensors, medical equipment, etc.); industrial equipment (e.g., robots, factory machinery, construction equipment, industrial sensors, etc.); retail equipment (e.g., vending machines, point of sale (POS) devices, Radio Frequency Identification (RFID) tags, etc.); smart city devices (e.g., street lamps, parking meters, waste management sensors, etc.); transportation and logistical equipment (e.g., turnstiles, rental car trackers, navigational devices, inventory monitors, etc.); and so forth.

In some embodiments, the network fabric 120 can support wired and wireless access as part of a single integrated infrastructure such that connectivity, mobility, and policy enforcement behavior are similar or the same for both wired and wireless endpoints. This can bring a unified experience for users, devices, and things that is independent of the access media.

In integrated wired and wireless deployments, control plane integration can be achieved with the wireless network infrastructure equipment 108 notifying the fabric control plane nodes 110 of joins, roams, and disconnects by the wireless endpoints 130 such that the fabric control plane nodes can have connectivity information about both wired and wireless endpoints in the network fabric 120, and can serve as the single source of truth for endpoints connected to the network fabric. For data plane integration, the wireless network infrastructure equipment 108 can instruct the fabric wireless base stations and access points 128 to form a VXLAN overlay tunnel to their adjacent fabric edge nodes 126. The VXLAN tunnel can carry segmentation and policy information to and from the fabric edge nodes 126, allowing connectivity and functionality identical or similar to that of a wired endpoint. When the wireless endpoints 130 join the network fabric 120 via the fabric wireless base stations and access points 128, the wireless network infrastructure equipment 108 can onboard the endpoints into the network fabric 120 and inform the fabric control plane nodes 110 of the endpoints' Media Access Control (MAC) addresses (or other identifiers). The wireless network infrastructure equipment 108 can then instruct the fabric wireless base stations and access points 128 to form VXLAN overlay tunnels to the adjacent fabric edge nodes 126. Next, the wireless endpoints 130 can obtain IP addresses for themselves via Dynamic Host Configuration Protocol (DHCP). Once that completes, the fabric edge nodes 126 can register the IP addresses of the wireless endpoint 130 to the fabric control plane nodes 110 to form a mapping between the endpoints' MAC and IP addresses, and traffic to and from the wireless endpoints 130 can begin to flow.

FIG. 1B illustrates an example of a software architecture or logical architecture 200 for an enterprise network. One of ordinary skill in the art will understand that, for the logical architecture 200 and any system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure. In this example, the logical architecture 200 includes a management layer 202, a controller layer 221, a network layer 231, the physical layer 241, and a shared services layer 251.

The management layer 202 can abstract the complexities and dependencies of other layers and provide a user with tools and workflows to manage an enterprise network (e.g., the enterprise network 100). The management layer 202 can include a user interface 204, design functions 206, policy functions 208, provisioning functions 211, assurance functions 213, platform functions 214, and base automation functions. The user interface 204 can provide a user a single point to manage and automate the network. The user interface 204 can be implemented within a web application/web server accessible by a web browser and/or an application/application server accessible by a desktop application, a mobile app, a shell program or other command line interface (CLI), an Application Programming Interface (e.g., restful state transfer (REST), Simple Object Access Protocol (SOAP), Service Oriented Architecture (SOA), etc.), and/or other suitable interface in which the user can configure network infrastructure, devices, and things that are cloud-managed; provide user preferences; specify policies, enter data; review statistics; configure interactions or operations; and so forth. The user interface 204 may also provide visibility information, such as views of a network, network infrastructure, computing devices, and things. For example, the user interface 204 can provide a view of the status or conditions of the network, the operations taking place, services, performance, a topology or layout, protocols implemented, running processes, errors, notifications, alerts, network structure, ongoing communications, data analysis, and so forth.

The design functions 206 can include tools and workflows for managing site profiles, maps and floor plans, network settings, and IP address management, among others. The policy functions 208 can include tools and workflows for defining and managing network policies. The provisioning functions 211 can include tools and workflows for deploying the network. The assurance functions 213 can use machine learning and analytics to provide end-to-end visibility of the network by learning from the network infrastructure, endpoints, and other contextual sources of information. The platform functions 214 can include tools and workflows for integrating the network management system with other technologies. The base automation functions can include tools and workflows to support the policy functions 208, the provisioning functions 211, the assurance functions 213, and the platform functions 214.

In some embodiments, the design functions 206, the policy functions 208, the provisioning functions 211, the assurance functions 213, the platform functions 214, and the base automation functions can be implemented as microservices in which respective software functions are implemented in multiple containers communicating with each rather than amalgamating all tools and workflows into a single software binary. Each of the design functions 206, policy functions 208, provisioning functions 211, assurance functions 213, and platform functions 214 can be viewed as a set of related automation microservices to cover the design, policy authoring, provisioning, assurance, and cross-platform integration phases of the network lifecycle. The base automation functions can support the top-level functions by allowing users to perform certain network-wide tasks.

The controller layer 221 can comprise subsystems for the management layer 202 and may include a network control platform 222, a network data platform 224, and AAA services 226. These controller subsystems can form an abstraction layer to hide the complexities and dependencies of managing many network devices and protocols.

The network control platform 222 can provide automation and orchestration services for the network layer 231 and the physical layer 241, and can include the settings, protocols, and tables to automate management of the network and physical layers. For example, the network control platform 222 can provide the design functions 206, the policy functions 208, the provisioning functions 211, and the platform functions 214. In addition, the network control platform 222 can include tools and workflows for discovering switches, routers, wireless controllers, and other network devices (e.g., the network discovery tool); maintaining network and endpoint details, configurations, and software versions (e.g., the inventory management tool); Plug-and-Play (PnP) for automating deployment of network infrastructure (e.g., the network PnP tool), Path Trace for creating visual data paths to accelerate the troubleshooting of connectivity problems, Easy QoS for automating quality of service to prioritize applications across the network, and Enterprise Service Automation (ESA) for automating deployment of physical and virtual network services, among others. The network control platform 222 can communicate with network devices using Network Configuration (NETCONF)/Yet Another Next Generation (YANG), Simple Network Management Protocol (SNMP), Secure Shell (SSH)/Telnet, and so forth. In some embodiments, the Cisco® Network Control Platform (NCP) can operate as the network control platform 222.

The network data platform 224 can provide for network data collection, analytics, and assurance, and may include the settings, protocols, and tables to monitor and analyze network infrastructure and endpoints connected to the network. The network data platform 224 can collect multiple types of information from network devices, including System Logging Protocol (“syslog”), SNMP, NetFlow, Switched Port Analyzer (SPAN), and streaming telemetry, among others. The network data platform 224 can also collect use contextual information shared from the network devices. Syslog is a protocol that can be used to send system log or event messages to a server (e.g., a syslog server). The syslog can collect logs from various devices to monitor and review data.

In some embodiments, one or more Cisco DNA™ Center appliances can provide the functionalities of the management layer 202, the network control platform 222, and the network data platform 224. The Cisco DNA™ Center appliances can support horizontal scalability by adding additional Cisco DNA™ Center nodes to an existing cluster; high availability for both hardware components and software packages; backup and store mechanisms to support disaster discovery scenarios; role-based access control mechanisms for differentiated access to users, devices, and things based on roles and scope; and programmable interfaces to enable integration with third party vendors. The Cisco DNA™ Center appliances can also be cloud-tethered to provide for the upgrade of existing functions and additions of new packages and applications without having to manually download and install them.

The AAA services 226 can provide identity and policy services for the network layer 231 and physical layer 241, and may include the settings, protocols, and tables to support endpoint identification and policy enforcement services. The AAA services 226 can provide tools and workflows to manage virtual networks and security groups, and to create group-based policies and contracts. The AAA services 226 can identify and profile network devices and endpoints using AAA/RADIUS, 802.1X, MAC Authentication Bypass (MAB), web authentication, and EasyConnect, among others. The AAA services 226 can also collect and use contextual information from the network control platform 222, the network data platform 224, and the shared services layer 251, among others. In some embodiments, Cisco® ISE can provide the AAA services 226.

The network layer 231 can be conceptualized as a composition of two layers, an underlay 234 comprising physical and virtual network infrastructure (e.g., routers, switches, WLCs, etc.) and a Layer 3 routing protocol for forwarding traffic, and an overlay 232 comprising a virtual topology for logically connecting wired and wireless users, devices, and things and applying services and policies to these entities. Network devices of the underlay 234 can establish connectivity between each other, such as via IP. The underlay may use any topology and routing protocol.

In some embodiments, the network controller appliances 104 can provide a local area network (LAN) automation service, such as implemented by Cisco DNA™ Center LAN Automation, to automatically discover, provision, and deploy network devices. Once discovered, the automated underlay provisioning service can leverage Plug and Play (PnP) to apply the required protocol and network address configurations to the physical network infrastructure. In some embodiments, the LAN automation service may implement the Intermediate System to Intermediate System (IS-IS) protocol. Some of the advantages of IS-IS include neighbor establishment without IP protocol dependencies, peering capability using loopback addresses, and agnostic treatment of IPv4, IPv6, and non-IP traffic.

The overlay 232 can be a logical, virtualized topology built on top of the physical underlay 234, and can include a fabric data plane, a fabric control plane, and a fabric policy plane. In some embodiments, the fabric data plane can be created via packet encapsulation using Virtual Extensible LAN (VXLAN) with Group Policy Option (GPO). Some of the advantages of VXLAN-GPO include its support for both Layer 2 and Layer 3 virtual topologies (overlays), and its ability to operate over any IP network with built-in network segmentation.

In some embodiments, the fabric control plane can implement Locator/Identifier Separation Protocol (LISP) for logically mapping and resolving users, devices, and things. LISP can simplify routing by removing the need for each router to process every possible IP destination address and route. LISP can achieve this by moving remote destination to a centralized map database that allows each router to manage only its local routs and query the map system to locate destination endpoints.

The fabric policy plane is where intent can be translated into network policy. That is, the policy plane is where the network operator can instantiate logical network policy based on services offered by the network fabric 120, such as security segmentation services, QoS, capture/copy services, application visibility services, and so forth.

Segmentation is a method or technology used to separate specific groups of users or devices from other groups for the purpose of reducing congestion, improving security, containing network problems, controlling access, and so forth. As discussed, the fabric data plane can implement VXLAN encapsulation to provide network segmentation by using the virtual network identifier (VNID) and Scalable Group Tag (SGT) fields in packet headers. The network fabric 120 can support both macro-segmentation and micro-segmentation. Macro-segmentation logically separates a network topology into smaller virtual networks by using a unique network identifier and separate forwarding tables. This can be instantiated as a Virtual Routing and Forwarding (VRF) instance and referred to as a Virtual Network (VN). That is, a VN is a logical network instance within the network fabric 120 defined by a Layer 3 routing domain and can provide both Layer 2 and Layer 3 services (using the VNID to provide both Layer 2 and Layer 3 segmentation). Micro-segmentation logically separates user or device groups within a VN, by enforcing source to destination access control permissions, such as by using access control lists (ACLs). A scalable group is a logical object identifier assigned to a group of users, devices, or things in the network fabric 120. It can be used as source and destination classifiers in Security Group ACLs (SGACLs). The SGT can be used to provide address-agnostic group-based policies.

In some embodiments, the fabric control plane node 110 may implement the Locator/Identifier Separation Protocol (LISP) to communicate with one another and with the management cloud 102. Thus, the control plane nodes may operate a host tracking database, a map server, and a map resolver. The host tracking database can track the endpoints 130 connected to the network fabric 120 and associate the endpoints to the fabric edge nodes 126, thereby decoupling an endpoint's identifier (e.g., IP or MAC address) from its location (e.g., closest router) in the network.

The physical layer 241 can comprise various network devices, such as the switches and routers 110, 122, 124, and 126, the wireless network infrastructure equipment 108, the wireless base stations and access points 128, the network controller appliances 104, and the AAA appliances 106, among others.

The shared services layer 251 can provide an interface to external network services, such as cloud services 252; Domain Name System (DNS), DHCP, IP Address Management (IPAM), and other network address management services 254; firewall services 256; Network as a Sensor (NaaS)/Encrypted Threat Analytics (ETA) services 258; and Virtual Network Functions (VNFs) 260; among others. The management layer 202 and/or the controller layer 221 can share identity, policy, forwarding information, and so forth via the shared services layer 251 using APIs.

FIG. 2 illustrates of an example of a heterogeneous wireless network 201, such as a network capable of providing User Equipment (UE) devices network access via a Wi-Fi network, cellular network, CBRS, and/or other radio network. In this example, the heterogeneous wireless network 201 includes User Equipment (UE) devices 203 (shown as circles), CBRS Devices (CBSDs) 210 (e.g., CBSD1 and CBSD2), CBRS APs 212 (e.g., CBRS AP 1, 2, . . . , x), base stations 220 (e.g., BS1, . . . , Bz) of a public radio network, Wi-Fi access points 230 (e.g., Wi-Fi AP1, 2, . . . , y), a Spectrum Access System (SAS) 240, a network controller 250, and a public IP network 260. Some of the CBSDs 210 may include CBRS APs 212. The CBSDs 210, BSs 220, and Wi-Fi APs 230 can connect the UE devices 203 to the public IP network 260. The public IP network 260 may include a public data network, such as the Internet.

In FIG. 2, at least some of the UE devices 203 may be CBRS-enabled such that they can connect to the public IP network 260 via a CBRS network. For example, the UE devices 203 can attach to a CBRS network comprising the CBRS APs 212. Some of the CBRS APs 212 may be standalone devices, such as the CBRS AP 2 and CBRS AP x, while others can be integrated with other components and are part of another device such as is the case for the CBRS AP 1 and CBRS AP 3 in which the CBRS AP 1 is part of the CBSD 1 and CBRS AP 3 is part of the CBSD 2.

The CBSD 1 may also include a controller (not shown). A CBSD that includes a controller can be an evolved NodeB (eNodeB), defined in a Universal Mobile Telecommunications System (UMTS) standard. The CBSD 2 may be an integrated AP device that includes the CBRS AP 3 and also the Wi-Fi AP 2.

The SAS 240 can operate as a controller for the CBSDs 210 and the CBRS APs 212. The SAS 240 can manage the CBRS spectrum and maintain a database of spectrum usage by all users, including Tier 1 users, Tier 2 users, and Tier 3 users (as shown in Table 1), in all census tracts or areas. The SAS 240 can allocate channels to the CBRS APs 212 using a variety of rules. For example, the SAS 240 can consider multiple factors and inform the CBRS APs 212 and the CBSDs 210 of the operating parameters including allocated frequency band, allocated channel, and/or maximum effective isotropic radiated power that can be used at a given point in time. The SAS 240 can also provide the FCC required 300 second notification that an enterprise (e.g., a Tier 3 or GAA user) needs to offload its UE devices 203 from the CBRS network.

When the enterprise is forced to offload its UE devices 203, the UE devices 203 may be offloaded to a cellular network provided via the BSs 220 or to a Wi-Fi network provided via the Wi-Fi APs 230. In FIG. 2, based on the 300 second notification provided by the SAS 240 to the CBSD 1, a set of UE devices 203 attached to the CBRS AP 1 (shaded circles) may be offloaded from the CBRS AP 1 to the BSz, as an example. The set of the UE devices 203 can continue to obtain access to the public IP network 260 via the BSz and are offloaded from the CBRS network. According to another example embodiment, another set of the UE devices 203 (e.g., cross hatched circles) may be offloaded to a Wi-Fi network provided via the Wi-Fi AP y.

The Wi-Fi APs 230 can be managed and controlled by the network controller 250. The network controller 250 may include a WLC. In one example embodiment, the network controller 250 may also include an interworking function (IWK) to manage the CBRS APs 212 or operate as a controller for at least some of the CBRS APs 212. The network controller 250 may generate policies and push the policies to various access points for execution. For example, the network controller 250 may run analytics to develop CBRS offloading policies. It is also possible, however, some or all of the functions of the network controller 250 may be implemented within one or more of the CBSDs 210 or the CBRS APs 212.

The enterprise network landscape is continuously evolving. There is a greater demand for mobile and Internet of Things (IoT) device traffic, Software as a Service (SaaS) applications, and cloud adoption. In addition, security needs are increasing and certain applications can require prioritization and optimization for proper operation. As this complexity grows, there is a push to reduce costs and operating expenses while providing for high availability and scale.

In conventional enterprise deployments, introduction of security is tied to a network topology. However, such a topology includes several disadvantages. In some deployments, customers may require a firewall to be inserted in the network to monitor the east-west traffic for compliance requirements. However, the volume of east-west traffic is minimal, which results in lightly-loaded firewalls. In other deployments, firewalls are positioned at a particular point in the network that creates a network traffic bottleneck because of the volume of traffic that needs to be processed at the particular point in the network. Furthermore, installing multiple firewalls incurs significant operational and capital expenditure.

Not only are firewalls utilized to increase security, but encryption is also a factor when considering security functions in the enterprise. With an increase in the volume of encrypted traffic, the capacity of the firewall will be pressured by the need to successfully compute intensive decryption of the encrypted data.

The current approach for including security services is completely dependent on the topology. Some vendors host security in a cloud. However, this approach includes challenges including the inability to pass the required context to the cloud. Also, this approach consumes expensive WAN bandwidth to get all of the network traffic to the cloud. Furthermore, it is very challenging to get the enterprise local traffic to the cloud. Another approach includes the introduction of a physical firewall, but this includes similar challenges as described above.

As such, a need exists to decouple security processing from their dependency on topologies. Having a mechanism to engineer traffic towards the firewall in a location agnostic manner assists in optimizing usage of the firewall resources, while at the same time ensuring a highly available security solution.

In an example, the network architecture includes the ability to leverage the network by identifying the network traffic that needs to be subjected to security functions and re-directing a subset of the network traffic to specific security functions. The security functions need not be in a packet path, but can be hosted in physical or virtual form factors on premise. Alternatively, the security functions can be hosted in a cloud. This will allow an operator to expand the security capabilities elastically on demand. The capacity can be monitored actively and additional capacity can be added on demand. This configuration can allow load-balancing of network traffic across multiple security instances. In one example, there is a place for defining policies for various security instances. This ensures that a consistent enterprise-wide security policy occurs across all security instances.

The network architecture can be operationalized by building a security overlay that can allow the network traffic to be steered towards to the security functions. The security overlay can include: 1) supporting cloud hosted firewalls; 2) supporting Cisco® as well as third party firewalls; and 3) supporting software-defined access (SDA) and non-SDA deployments.

For SDA deployments, a fabric border node can be a part of the security overlay that is set up with a security service node. A tunnel set up can be based on the location of the firewall. For cloud-hosted firewalls, an Internet Protocol Security (“IPSec”) tunnel can be set up to the cloud-hosted firewall, which can be used to send selected traffic to the cloud-hosted firewall. Furthermore, another tunnel can be set up between the cloud and the fabric border node such that all of the security-processed traffic can be sent back without losing context that may be required for policy decisions within the fabric. The same approach can be adopted for non-SDA deployments, but the tunnel can be set up from an access switch.

To support Cisco® and 3rd party firewalls, the fabric border node can use Virtual Extensible LAN (“VxLAN”) encapsulation (with a Secure Group Tag (SGT)) to send the traffic to the firewall, which can decapsulate the traffic and apply the security functions. Thereafter, the firewall can forward the traffic onwards or re-encapulate to retain context and send the traffic back to the fabric border node. In one example, a Cisco® DNA Center (“DNA-C”) can perform the function of automating the enablement of the configurations on the network and firewalls to set up the security overlay.

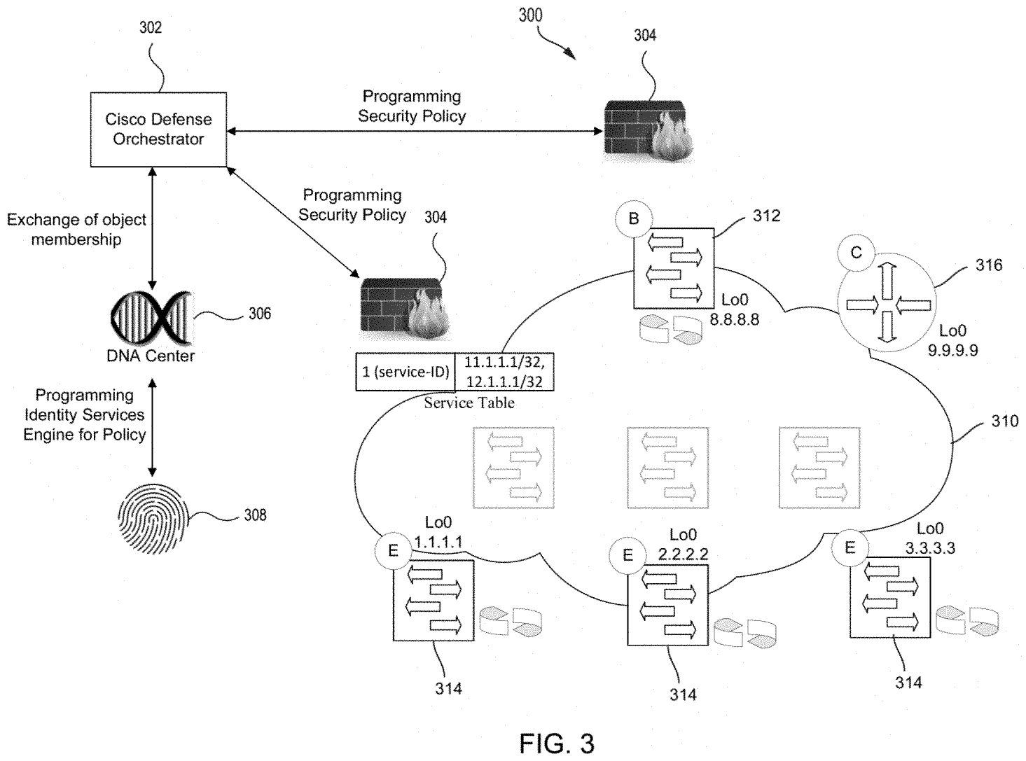

FIG. 3 illustrates an example of a topology for an enterprise network 300 including policy enablement, in accordance with some embodiments. The enterprise network 300 can include a Cisco Defense Orchestrator (CDO) 302, firewalls 304, a Digital Network Architecture (DNA) Center 306, an Identity Services Engine (ISE) 308, and a network fabric 310. The network fabric 310 can include border nodes 312, edge nodes 314, and control plane nodes 316 as described above.

The ISE 308 can provide policies that can be distributed throughout the enterprise network 300. For example, the policies can be programmed by the ISE 308 and provided to the DNA Center 306. The DNA Center 306 can further exchange object membership with the CDO 302. The CDO 302 can then provide the policies to the firewalls 304 to program security policies.

In some instances, the policies can be enabled by the CDO 302 including segmentation policies, L7 firewall policies, Intrusion Prevention System (IPS) policies, file inspection policies, Uniform Resource Locator (URL) filtering policies, Secure Sockets Layer (SSL) decryption policies, or any other policy suitable for the intended purpose and understood by a person of ordinary skill in the art.

Policies that are enabled by the ISE 308 can include groups of policies for which data traffic needs can be re-directed for security processing, e.g., programmed by the DNA Center 306, to the edge nodes 314 of the network fabric 310.

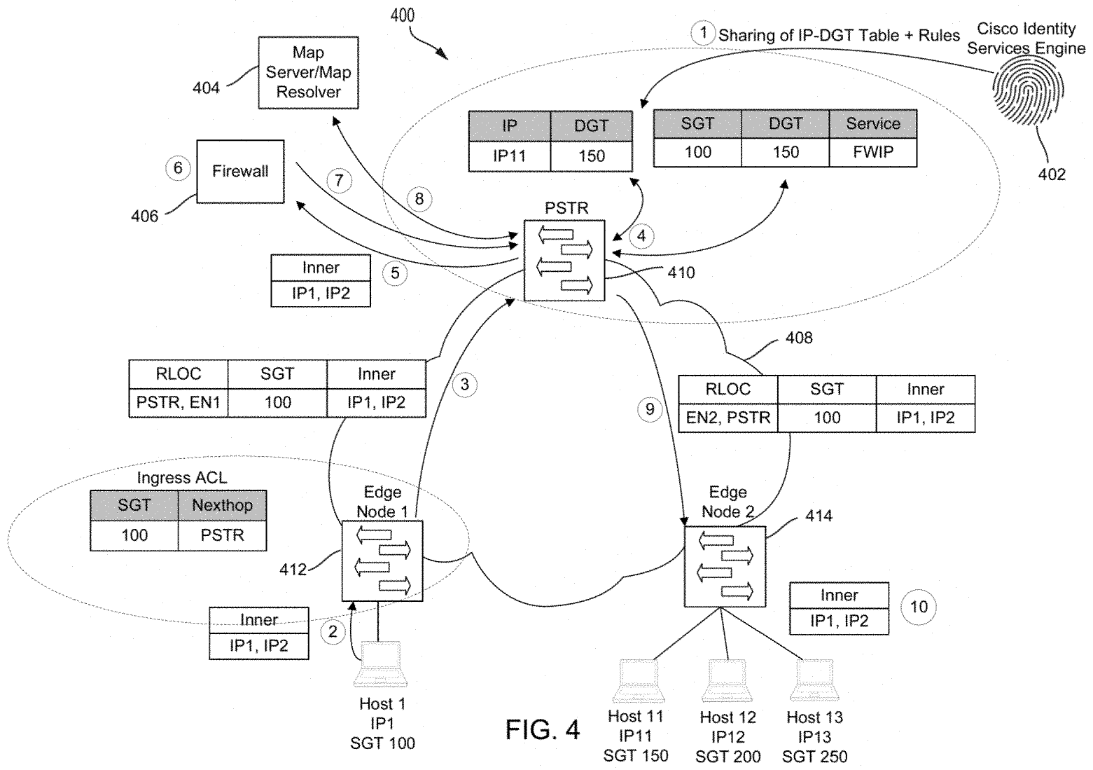

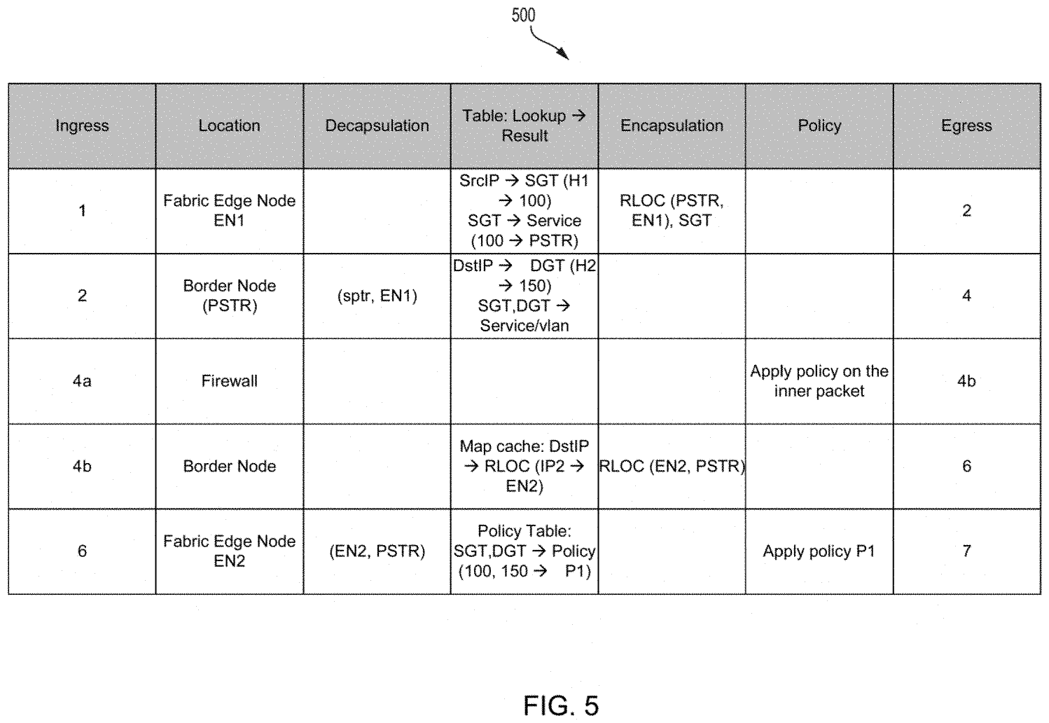

FIG. 4 illustrates an example of a topology for an enterprise network 400 where firewalls 406 may not be a part of a network fabric 408, in accordance with some embodiments. In some instances, the enterprise network 400 can include an Identity Services Engine (ISE) 402, a Map Server/Map Resolver (MS/MR) 404, the firewall 406, and the network fabric 408. The network fabric 408 can include a PSTR 410 (e.g., a border node) and edge nodes 412, 414. The network fabric 408 may further not include the firewall 406. FIGS. 4 and 5 further illustrate the flow and an example lookup table of packets.

At step (1), the ISE 402 of the enterprise network 400 can include providing Internet Protocol (IP)-Destination Group Tag (DGT) tables and rules to a fabric border node (e.g., PSTR 410) of the network fabric 408. In some instances, as shown in FIG. 4, the table and rules may include values such as IP: IP11, DGT: 150, Security Group Tag (SGT): 100, DGT: 150, and Service: Firewall IP (FWIP). In some instances, the table and rules may include polices, information relating to destination points, routing information, or any other data suitable of the intended purpose and understood by a person of ordinary skill in the art.

At step (2), Host 1 may communicate with Host 11 by directing data traffic (e.g., a data packet including Inner: IP1, IP2) to the edge node 412 (EN1). In some instances, an IP→SGT mapping may provide a value of 100.

At step (3), the edge node 412 may encapsulate data traffic from the Host 1 and provide the data traffic to the PSTR 410. The data traffic may include information such as Router Locator (“RLOC”): PSTR, EN1, SGT: 100, and Inner: IP1, IP2. A lookup of SGT: 100 may point to the PSTR 410 from the edge node 412 (EN1).

At step (4), the PSTR 410 may decapsulate the data packet received from the edge node 412. The data packet may include a lookup of an Inner IP source (SRC) and destination IP addresses IP1, IP11. In the IP-SGT table, values IP1, IP11 may provide corresponding values of SGT: 100 and DGT: 150. Values 100 (SGT) and 150 (DGT) may correspond to the IP address of the firewall 406 according to the lookup service table as provided in step (1).

At step (5), the PSTR 410 can send the decapsulated data packet to the firewall 406.

At step (6), the firewall 406 can receive the decapsulated data packet and perform rules on the decapsulated data packet.

At step (7), the firewall 406 can provide the processed data packet to the PSTR 410 by Virtual Local Area Network (VLAN) switching and routing or any other method suitable for the intended purpose and understood by a person of ordinary skill in the art.

At step (8), the PSTR 410 (e.g., border node) can recognize that the data packet was received from the firewall 406 and perform a map cache query (with the MS/MR 404) for IP11, which can point to RLOC of the edge node 414 (e.g., EN2).

At step (9), the PSTR 410 can encapsulate the data traffic and utilize the IP-SGT table of step (1) to supplement the data packet by including information relating to the SGT (e.g., SGT: 100) and the RLOC (e.g., EN2, PSTR).

At step (10), the data packet (e.g., Inner: IP1, IP2) can be routed to the Host 11 at IP11 as initially directed by the Host 1.

FIG. 5 illustrates a table 500 in accordance with the embodiment of FIG. 4, in accordance with some embodiments.

In row 1 (ingress 1 to egress 2) of the table 500, the fabric edge node 412 (e.g., EN1) can utilize the table to lookup results. For example, a lookup for the source IP (SrcIP) (e.g., H1) can result in an SGT value of 100, and a lookup for the SGT value of 100 can result in the Service of PSTR. Row 1 can further include the fabric edge node 412 encapsulating the data packet with an RLOC of PSTR, EN1, SGT.

In row 2 (ingress 2 to egress 4) of the table 500, the border node 410 (e.g., PSTR) can utilize the table to lookup results. For example, a lookup for a destination IP (DstIP) (e.g., Host2) can result in a DGT value of 150, and a lookup for an SGT, DGT value can result in a Service/vlan. Row 2 can further include the border node 410 decapsulating the data packet with the PSTR, EN1.

In row 3 (ingress 4a to egress 4b) of the table 500, the firewall 406 can apply the policy to the inner packet (e.g., data packet).

In row 4 (ingress 4b to egress 6) of the table 500, the border node 410 (e.g., PSTR) can utilize the table to lookup results and a map cache. For example, a lookup for a DstIP (e.g., IP2) can result in an RLOC of EN2. Row 4 can further include the border node 410 encapsulating the data packet with an RLOC of EN2, PSTR.

In row 5 (ingress 6 to egress 7) of the table 500, the fabric edge node 414 (e.g., EN2) can utilize a policy table to lookup results. For example, a lookup for SGT, DGT (e.g., 100, 150) can result in a Policy (e.g., P1). Row 5 can further include the fabric edge node 414 decapsulating the data packet with EN2 and PSTR.

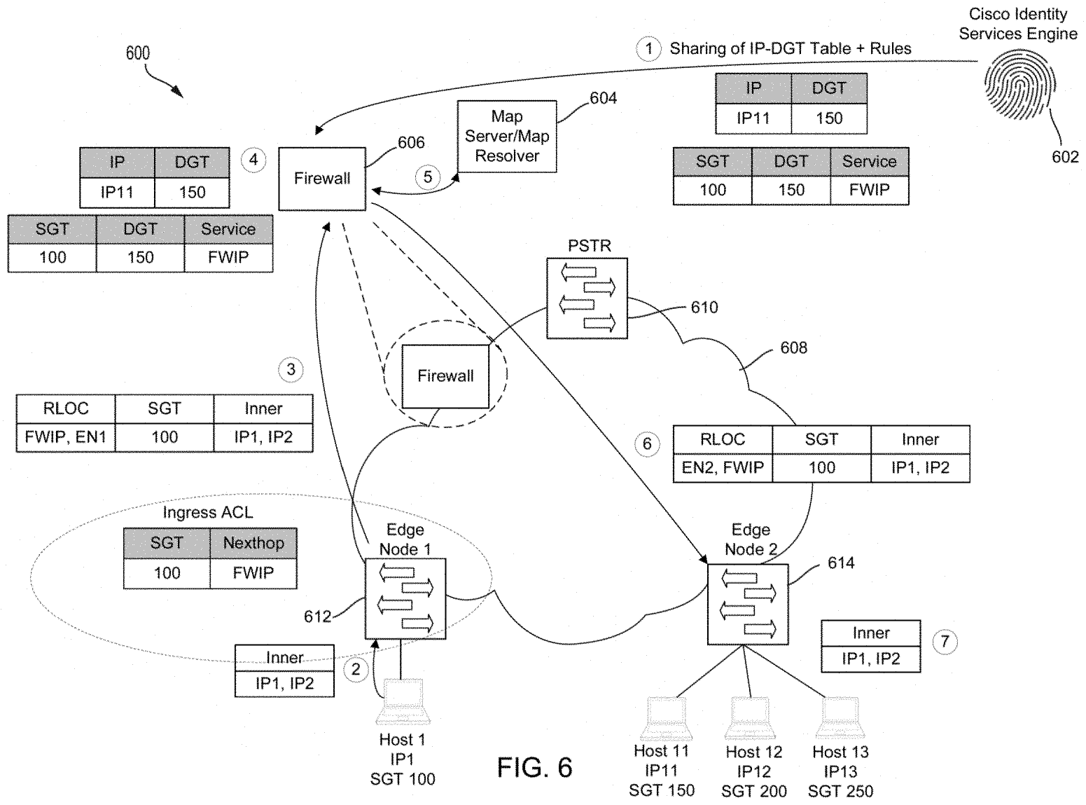

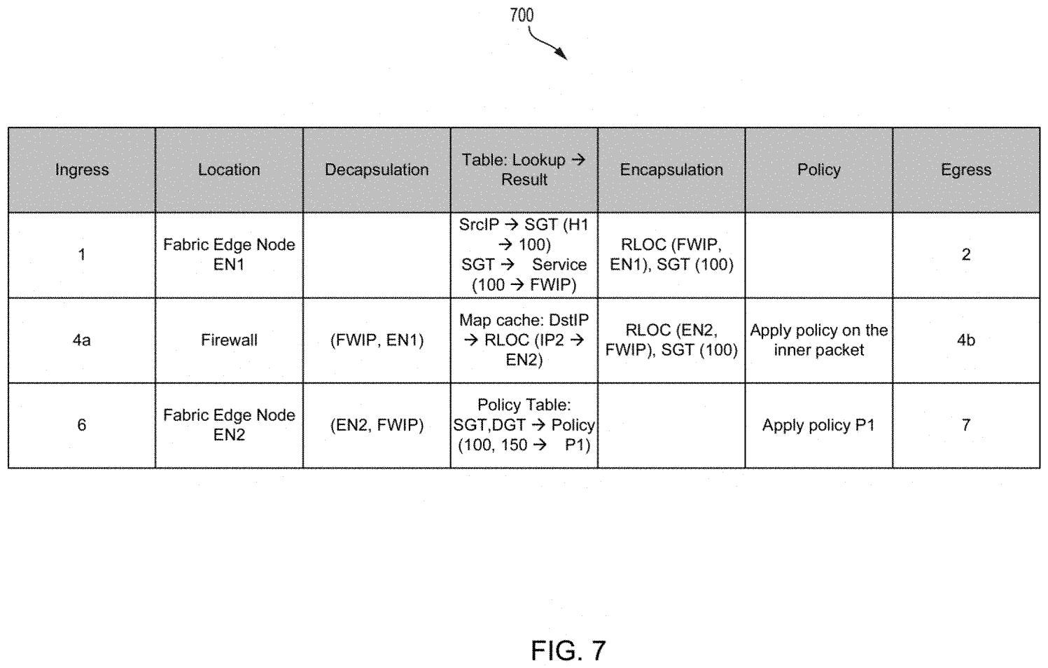

FIG. 6 illustrates an example of a topology for an enterprise network 600 where firewalls 606 may be a part of a network fabric 608, in accordance with some embodiments. In some instances, the enterprise network 600 can include an Identity Services Engine (ISE) 602, a Map Server/Map Resolver (MS/MR) 604, the firewall 606, and the network fabric 608. The network fabric 608 can include the firewall 606, a PSTR 610 (e.g., a border node), and edge nodes 612, 614. FIGS. 6 and 7 further illustrate the flow and an example lookup table of packets.

At step (1), the ISE 602 of the enterprise network 600 can include providing Internet Protocol (IP)-Destination Group Tag (DGT) tables and rules to the firewall 606 and/or the fabric border node (e.g., PSTR 610). The firewall 606 can be a part of the network fabric 608 that can communicatively coupled to the fabric border node 610, which may not be directly connected to the firewall 606. In some instances, as shown in FIG. 6, the table and rules may include values such IP: IP11, DGT: 150, Security Group Tag (SGT): 100, DGT: 150, and Service: Firewall IP (FWIP). In some instances, the table and rules may include polices, information relating to destination points, routing information, or any other data suitable of the intended purpose and understood by a person of ordinary skill in the art.

At step (2), Host 1 may communicate with Host 11 by directing data traffic (e.g., a data packet including Inner: IP1, IP2) to the edge node 612 (EN1). In some instances, an IP→SGT mapping may provide a value of 100.

At step (3), the edge node 612 can encapsulate data traffic from the Host 1 and provide the data traffic to the firewall 606. The data traffic may include information such as Router Locator (“RLOC”): FWIP, EN1, SGT: 100, and Inner: IP1, IP2. A lookup of SGT: 100 may point to the firewall 606 from the edge node 612 (EN1).

At step (4), the firewall 606 may decapsulate the data packet received from the edge node 612. The data packet may include a lookup of an Inner IP source (SRC) and destination IP addresses IP1, IP11. In the IP-SGT table, values IP1, IP11 may provide corresponding values of SGT: 100 and DGT: 150. In some instances, the firewall 406 can perform rules on the decapsulated data packet received from the edge node 612.

At step (5), the firewall 606 can perform a map cache query (with the MS/MR 604) for IP11, which can point to the RLOC of the edge node 614 (e.g., EN2).

At step (6), the firewall 606 can encapsulate the data traffic and utilize the IP-SGT table of step (1) to supplement the data packet by including information relating to the SGT (e.g., SGT: 100) and the RLOC (e.g., EN2, FWIP).

At step (7), the data packet (e.g., Inner: IP1, IP2) can be routed to the Host 11 at IP11 as initially directed by the Host 1.

FIG. 7 illustrates a table 700 in accordance with the embodiment of FIG. 6, in accordance with some embodiments.

In row 1 (ingress 1 to egress 2) of the table 700, the fabric edge node 612 (e.g., EN1) can utilize the table to lookup results. For example, a lookup for the source IP (SrcIP) (e.g., H1) can result in an SGT value of 100, and a lookup for the SGT value of 100 can result in the Service of FWIP. Row 1 can further include the fabric edge node 612 encapsulating the data packet with an RLOC of FWIP, EN1, SGT.

In row 2 (ingress 4a to egress 4b) of the table 700, the firewall 606 can utilize the table to lookup results and a map cache. For example, a lookup for a DstIP (e.g., IP2) can result in an RLOC of EN2. Row 2 can further include the firewall 606 encapsulating the data packet with an RLOC of EN2, FWIP with an SGT value of 100. In some instances, the firewall 606 can apply the policy to the inner packet (e.g., data packet).

In row 3 (ingress 6 to egress 7) of the table 700, the fabric edge node 614 (e.g., EN2) can utilize a policy table to lookup results. For example, a lookup for SGT, DGT (e.g., 100, 150) can result in a Policy (e.g., P1). Row 3 can further include the fabric edge node 614 decapsulating the data packet with EN2 and FWIP.

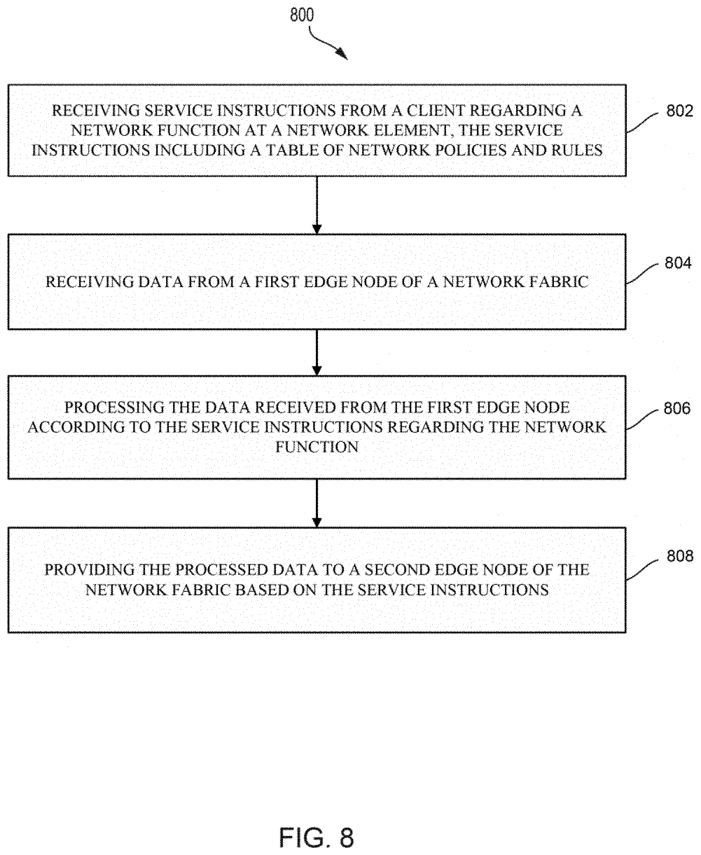

Having disclosed some example system components and concepts, the disclosure now turns to FIG. 8, which illustrate example method 800 for delivering security in a topology agnostic manner. The steps outlined herein are exemplary and can be implemented in any combination thereof, including combinations that exclude, add, or modify certain steps.

At step 802, the method 800 can include receiving service instructions from a client regarding a network function at a network element, the service instructions including a table of network policies and rules.

In some instances, the service instructions can include at least one of security functions or instructions for redirecting network traffic. The table of network policies and rules further can include at least one of ingress information, decapsulation information, encapsulation information, or egress information

In other instances, the network element can be at least one of a fabric border node of the network fabric or a firewall.

At step 804, the method 800 can include receiving data from a first edge node of a network fabric.

At step 806, the method 800 can include processing the data received from the first edge node according to the service instructions regarding the network function.

At step 808, the method 800 can include providing the processed data to a second edge node of the network fabric based on the service instructions.

In some instances, the method 800 can further include providing instructions to routers of the network fabric based on the service instructions regarding the network function.

In other instances, the method 800 can further include providing the data from the first edge node of the network fabric to a firewall designated in the service instructions. In some instances, the firewall can apply security functions included in the service instructions.

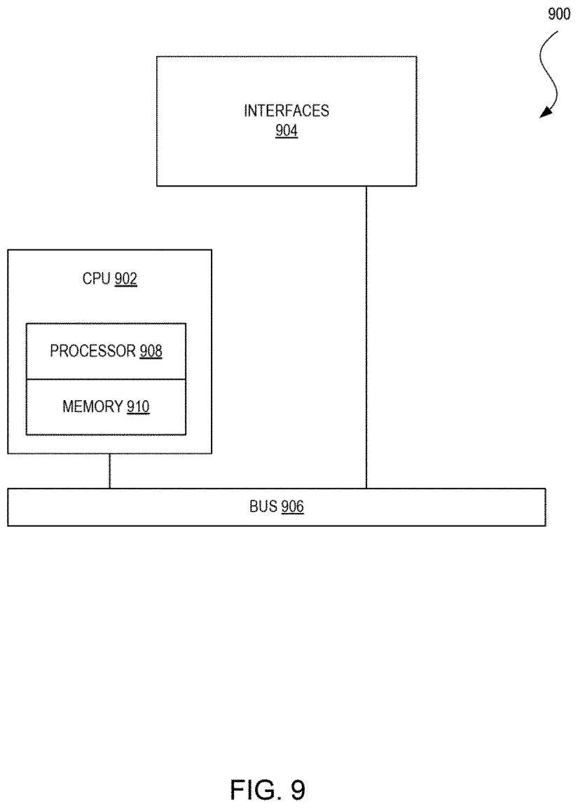

FIG. 9 further illustrates an example of a network device 900 (e.g., switch, router, network appliance, etc.). The network device 900 can include a master central processing unit (CPU) 902, interfaces 904, and a bus 906 (e.g., a PCI bus). When acting under the control of appropriate software or firmware, the CPU 902 can be responsible for executing packet management, error detection, and/or routing functions. The CPU 902 preferably accomplishes all these functions under the control of software including an operating system and any appropriate applications software. The CPU 902 may include one or more processors 908 such as a processor from the Motorola family of microprocessors or the MIPS family of microprocessors. In an alternative embodiment, the processor 908 can be specially designed hardware for controlling the operations of the network device 900. In an embodiment, a memory 910 (such as non-volatile RAM and/or ROM) can also form part of the CPU 902. However, there are many different ways in which memory could be coupled to the system.

An enterprise network can address the above and other security requirements with certain enhancements. For example, the enterprise network can create an International Mobile Subscriber Identity (IMSI) whitelist in an Authentication, Authorization, and Accounting (AAA) server. In addition to SIM authentication, the enterprise network can maintain the AAA server containing the IMSIs of enterprise-provisioned devices. After initial authentication, a Packet Data Network Gateway (PGW) can validate the IMSI with the local device. The enterprise can also create a mapping of IMSIs to International Mobile Equipment Identities (IMEIs) for (non-embedded) SIM cards. The cloud-hosted authentication system can maintain a mapping between IMSIs and IMEIs. This mapping can be controlled by the enterprise network. This can ensure a binding between device and SIM. After authentication, the mobile core can request the IMEI. It can further check if the IMEI maps to IMSI. The enterprise network can also deploy Virtual Routing and Forwarding (VRFs) instances based on device policy. The PGW can tunnel user traffic to specific VRFs.

The interfaces 904 can be provided as interface cards (sometimes referred to as line cards). The interfaces 904 can control the sending and receiving of data packets over the network and sometimes support other peripherals used with the network device 900. Among the interfaces that may be provided are Ethernet interfaces, frame relay interfaces, cable interfaces, Digital Subscriber Line (DSL) interfaces, token ring interfaces, and the like. In addition, various very high-speed interfaces may be provided such as a fast token ring interface, wireless interface, Ethernet interface, Gigabit Ethernet interface, Asynchronous Transfer Mode (ATM) interface, High-Speed Serial Interface (HSSI), Packet Over SONET (POS) interface, Fiber Distributed Data Interface (FDDI), and the like. The interfaces 904 may include ports appropriate for communication with the appropriate media. In some cases, the interfaces 904 may also include an independent processor and, in some instances, volatile RAM. The independent processors may control communication intensive tasks such as packet switching, media control, and management. By providing separate processors for the communication intensive tasks, the interfaces 904 may allow the CPU 902 to efficiently perform routing computations, network diagnostics, security functions, and so forth.

Although the system shown in FIG. 9 is an example of a network device of an embodiment, it is by no means the only network device architecture on which the subject technology can be implemented. For example, an architecture having a single processor that can handle communications as well as routing computations and other network functions, can also be used. Further, other types of interfaces and media may also be used with the network device 900.

Regardless of the network device's configuration, it may employ one or more memories or memory modules (including the memory 910) configured to store program instructions for general-purpose network operations and mechanisms for roaming, route optimization, and routing functions described herein. The program instructions may control the operation of an operating system and/or one or more applications. The memory or memories may also be configured to store tables such as mobility binding, registration, and association tables.

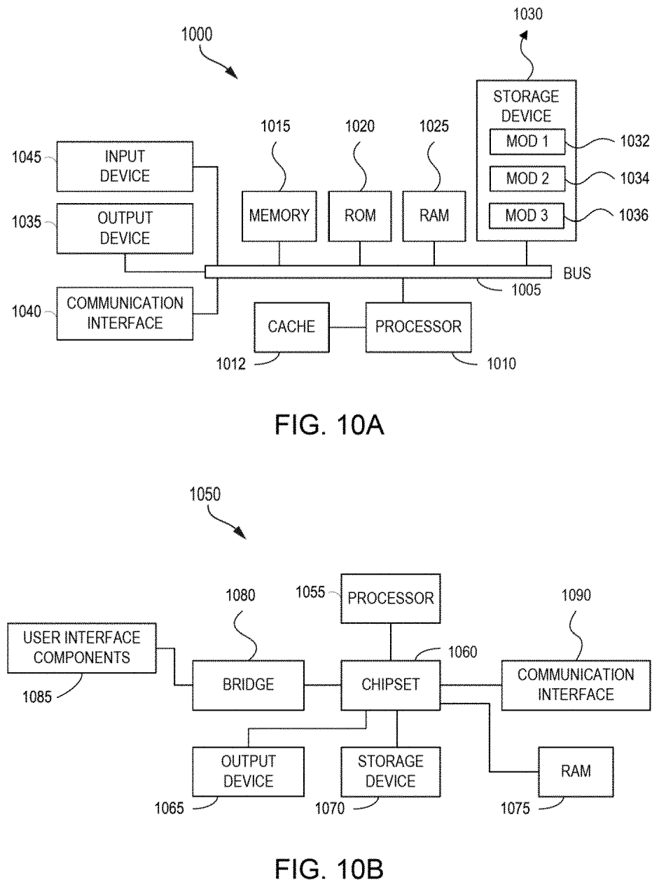

FIGS. 10A and 10B illustrate systems in accordance with various embodiments. The more appropriate system will be apparent to those of ordinary skill in the art when practicing the various embodiments. Persons of ordinary skill in the art will also readily appreciate that other systems are possible.

FIG. 10A illustrates an example of a bus computing system 1000 wherein the components of the system are in electrical communication with each other using a bus 1005. The computing system 1000 can include a processing unit (CPU or processor) 1010 and a system bus 1005 that may couple various system components including the system memory 1015, such as read only memory (ROM) 1020 and random access memory (RAM) 1025, to the processor 1010. The computing system 1000 can include a cache 1012 of high-speed memory connected directly with, in close proximity to, or integrated as part of the processor 1010. The computing system 1000 can copy data from the memory 1015, ROM 1020, RAM 1025, and/or storage device 1030 to the cache 1012 for quick access by the processor 1010. In this way, the cache 1012 can provide a performance boost that avoids processor delays while waiting for data. These and other modules can control the processor 1010 to perform various actions. Other system memory 1015 may be available for use as well. The memory 1015 can include multiple different types of memory with different performance characteristics. The processor 1010 can include any general purpose processor and a hardware module or software module, such as module 1 1032, module 2 1034, and module 3 1036 stored in the storage device 1030, configured to control the processor 1010 as well as a special-purpose processor where software instructions are incorporated into the actual processor design. The processor 1010 may essentially be a completely self-contained computing system, containing multiple cores or processors, a bus, memory controller, cache, etc. A multi-core processor may be symmetric or asymmetric.

To enable user interaction with the computing system 1000, an input device 1045 can represent any number of input mechanisms, such as a microphone for speech, a touch-protected screen for gesture or graphical input, keyboard, mouse, motion input, speech and so forth. An output device 1035 can also be one or more of a number of output mechanisms known to those of skill in the art. In some instances, multimodal systems can enable a user to provide multiple types of input to communicate with the computing system 1000. The communications interface 1040 can govern and manage the user input and system output. There may be no restriction on operating on any particular hardware arrangement and therefore the basic features here may easily be substituted for improved hardware or firmware arrangements as they are developed.

The storage device 1030 can be a non-volatile memory and can be a hard disk or other types of computer readable media which can store data that are accessible by a computer, such as magnetic cassettes, flash memory cards, solid state memory devices, digital versatile disks, cartridges, random access memory, read only memory, and hybrids thereof.

As discussed above, the storage device 1030 can include the software modules 1032, 1034, 1036 for controlling the processor 1010. Other hardware or software modules are contemplated. The storage device 1030 can be connected to the system bus 1005. In some embodiments, a hardware module that performs a particular function can include a software component stored in a computer-readable medium in connection with the necessary hardware components, such as the processor 1010, bus 1005, output device 1035, and so forth, to carry out the function.

FIG. 10B illustrates an example architecture for a chipset computing system 1050 that can be used in accordance with an embodiment. The computing system 1050 can include a processor 1055, representative of any number of physically and/or logically distinct resources capable of executing software, firmware, and hardware configured to perform identified computations. The processor 1055 can communicate with a chipset 1060 that can control input to and output from the processor 1055. In this example, the chipset 1060 can output information to an output device 1065, such as a display, and can read and write information to storage device 1070, which can include magnetic media, solid state media, and other suitable storage media. The chipset 1060 can also read data from and write data to RAM 1075. A bridge 1080 for interfacing with a variety of user interface components 1085 can be provided for interfacing with the chipset 1060. The user interface components 1085 can include a keyboard, a microphone, touch detection and processing circuitry, a pointing device, such as a mouse, and so on. Inputs to the computing system 1050 can come from any of a variety of sources, machine generated and/or human generated.

The chipset 1060 can also interface with one or more communication interfaces 1090 that can have different physical interfaces. The communication interfaces 1090 can include interfaces for wired and wireless LANs, for broadband wireless networks, as well as personal area networks. Some applications of the methods for generating, displaying, and using the technology disclosed herein can include receiving ordered datasets over the physical interface or be generated by the machine itself by the processor 1055 analyzing data stored in the storage device 1070 or the RAM 1075. Further, the computing system 1050 can receive inputs from a user via the user interface components 1085 and execute appropriate functions, such as browsing functions by interpreting these inputs using the processor 1055.

It will be appreciated that computing systems 1000 and 1050 can have more than one processor 1010 and 1055, respectively, or be part of a group or cluster of computing devices networked together to provide greater processing capability.

For clarity of explanation, in some instances the various embodiments may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Some examples of such form factors include general purpose computing devices such as servers, rack mount devices, desktop computers, laptop computers, and so on, or general purpose mobile computing devices, such as tablet computers, smart phones, personal digital assistants, wearable devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method comprising:
receiving service instructions from a client regarding a network function at a network element, the service instructions including a table of network policies and rules;
receiving data from a first edge node of a network fabric;
processing the data received from the first edge node according to the service instructions regarding the network function; and
providing the processed data to a second edge node of the network fabric based on the service instructions.

2. The computer-implemented method of claim 1, wherein the service instructions includes at least one of security functions or instructions for redirecting network traffic.

3. The computer-implemented method of claim 1, wherein the table of network policies and rules further includes at least one of ingress information, decapsulation information, encapsulation information, or egress information.

4. The computer-implemented method of claim 1, wherein the network element is at least one of a fabric border node of the network fabric or a firewall.

5. The computer-implemented method of claim 1, further comprising providing instructions to routers of the network fabric based on the service instructions regarding the network function.

6. The computer-implemented method of claim 1, further comprising providing the data from the first edge node of the network fabric to a firewall designated in the service instructions.

7. The computer-implemented method of claim 6, wherein the firewall applies security functions included in the service instructions.

8. A system comprising:
one or more processors; and
at least one computer-readable storage medium having stored therein instructions which, when executed by the one or more processors, cause the system to:
receive service instructions from a client regarding a network function at a network element, the service instructions including a table of network policies and rules;
receive data from a first edge node of a network fabric;
process the data received from the first edge node according to the service instructions regarding the network function; and
provide the processed data to a second edge node of the network fabric based on the service instructions.

9. The system of claim 8, wherein the service instructions includes at least one of security functions or instructions for redirecting network traffic.

10. The system of claim 8, wherein the table of network policies and rules further includes at least one of ingress information, decapsulation information, encapsulation information, or egress information.

11. The system of claim 8, wherein the network element is at least one of a fabric border node of the network fabric or a firewall.

12. The system of claim 8, wherein the instructions which, when executed by the one or more processors, cause the system to provide instructions to routers of the network fabric based on the service instructions regarding the network function.

13. The system of claim 8, wherein the instructions which, when executed by the one or more processors, cause the system to provide the data from the first edge node of the network fabric to a firewall designated in the service instructions.

14. The system of claim 13, wherein the firewall applies security functions included in the service instructions.

15. A non-transitory computer-readable storage medium comprising:
instructions stored on the non-transitory computer-readable storage medium, the instructions, when executed by one or more processors, cause the one or more processors to:
receive service instructions from a client regarding a network function at a network element, the service instructions including a table of network policies and rules;
receive data from a first edge node of a network fabric;
process the data received from the first edge node according to the service instructions regarding the network function; and
provide the processed data to a second edge node of the network fabric based on the service instructions.

16. The non-transitory computer-readable storage medium of claim 15, wherein the service instructions includes at least one of security functions or instructions for redirecting network traffic.

17. The non-transitory computer-readable storage medium of claim 15, wherein the table of network policies and rules further includes at least one of ingress information, decapsulation information, encapsulation information, or egress information.

18. The non-transitory computer-readable storage medium of claim 15, wherein the network element is at least one of a fabric border node of the network fabric or a firewall.

19. The non-transitory computer-readable storage medium of claim 15, wherein the instructions, when executed by one or more processors, cause the one or more processors to provide instructions to routers of the network fabric based on the service instructions regarding the network function.

20. The non-transitory computer-readable storage medium of claim 15, wherein the instructions, when executed by one or more processors, cause the one or more processors to provide the data from the first edge node of the network fabric to a firewall designated in the service instructions, wherein the firewall applies security functions included in the service instructions.
